(19) United States
(12) Patent Application Publication
(10) Pub. No.: US 2021/0039784 A1
(43) Pub. Date: Feb. 11, 2021

(54) AGRICULTURAL UNMANNED AERIAL VEHICLE

(71) Applicant: SZ DJI TECHNOLOGY CO., LTD., Shenzhen (CN)

(72) Inventors: Xiaolong WU, Shenzhen (CN); Lei DENG, Shenzhen (CN); Le ZHOU, Shenzhen (CN); Chuoying LU, Shenzhen (CN)

(21) Appl. No.: 17/080,229

(22) Filed: Oct. 26, 2020

Related U.S. Application Data
(63) Continuation of application No. PCT/CN2018/085096, filed on Apr. 28, 2018.

(51) Int. Cl. B64D 1/18; B64C 39/02

(52) U.S. Cl. CPC B64D 1/18; B64C 39/024; B64C 2201/128; B64C 2201/108; B64C 2201/027

(57) ABSTRACT

An agricultural unmanned aerial vehicle (UAV) is provided. The UAV includes a central frame, a control circuit, a left arm group, a right arm group and a spraying system. The left and right arm groups each includes a front arm assembly including a second rotor assembly, a rear arm assembly including a third rotor assembly, and a middle arm assembly including a first rotor assembly. In an output direction of downwash flow fields of the left and right arm groups, a height of a rotation plane of the first rotor assembly is lower than heights of rotation planes of the second and third rotor assemblies. The spraying system includes nozzle assemblies. The control circuit is configured to control the left and right arm groups to adjust flight attitude of the UAV. The left and right arm groups output the downwash flow fields in a direction towards the nozzle assemblies.

### CROSS-REFERENCE TO RELATED APPLICATION

This application is a continuation of International Application No. PCT/CN2018/085096, filed on Apr. 28, 2018, the entirety of which is incorporated herein by reference.

### TECHNICAL FIELD

The present disclosure generally relates to the field of unmanned aerial vehicle technology and, more particularly, relates to an agricultural unmanned aerial vehicle.

### BACKGROUND

In an existing technology, an agricultural unmanned aerial vehicle (UAV) can perform a liquid spraying operation during the flight, for example, the agricultural unmanned aerial vehicle sprays pesticides to perform a pest control operation, etc. The agricultural unmanned aerial vehicle is equipped with a spraying system for spraying the solution. The spraying system includes a water tank containing liquid, a nozzle assembly for spraying liquid outward, and a pump assembly for pressurizing the liquid. Further, the pump assembly is fixedly connected to the water tank or a fuselage of the unmanned aerial vehicle. One end of the nozzle assembly is connected to the water tank, and another end of the nozzle assembly is installed on an arm of the unmanned aerial vehicle and sprays liquid outward. The sprayed liquid sprays on the crops under the action of the downwash flow field of the agricultural unmanned aerial vehicle.

In related technologies, large-scale multi-rotor agricultural unmanned aerial vehicle includes following models: four-axis, six-axis and eight-axis multi-rotor agricultural unmanned aerial vehicle. Further, most of spraying unmanned aerial vehicles are four-axis and eight-axis multi-rotor agricultural unmanned aerial vehicles. The four-axis multi-rotor agricultural unmanned aerial vehicle merely has four propellers. During the spraying flight, the downwash flow field of the agricultural unmanned aerial vehicle is mainly generated by the four propellers of the four-axis UAV. Because the four-axis multi-rotor agricultural unmanned aerial vehicle has a substantially small area of the downwash flow field, the spraying range of the liquid is substantially small under the same structure and volume of a UAV with more axis, such as a six-axis UAV or an eight-axis UAV. As the spraying operation progresses, the volume of liquid carried by the agricultural unmanned aerial vehicle gradually decreases, the overall weight of the unmanned aerial vehicle gradually decreases, and the center of gravity of the unmanned aerial vehicle changes. Further, when the nozzle assembly sprays the liquid, the opposite reaction force acts on the rotor. Therefore, to maintain stable flight of the agricultural unmanned aerial vehicle, many factors need to be adjusted, and the spraying control is complicated.

During the spraying operation of the six-axis multi-rotor agricultural unmanned aerial vehicle, the downwash flow field of the six-axis multi-rotor agricultural unmanned aerial vehicle is mainly generated by six propellers, and the area of the downwash flow field is substantially large. However, because the downwash flow fields are independent from each other and are randomly distributed, the droplets spread and drift greatly. The eight-axis multi-rotor agricultural unmanned aerial vehicle has eight propellers. During the spraying flight, the downwash flow field of the agricultural unmanned aerial vehicle is mainly generated by the eight propellers. Although the area of the downwash flow fields of the eight propellers is substantially large, because the downwash flow fields are evenly distributed, the pressure of downwash flow field acting on the spraying position is small, which causes the pressure acting on the droplets to be small, and causes the penetration capacity of the droplets to be insufficient, thereby reducing the effect of spraying operation of the unmanned aerial vehicle. The disclosed agricultural unmanned aerial vehicle is directed to solve one or more problems set forth above and other problems.

### SUMMARY

One aspect of the present disclosure provides an agricultural unmanned aerial vehicle. The agricultural unmanned aerial vehicle includes a central frame, a control circuit installed on the central frame, and a left arm group and a right arm group symmetrically and fixedly disposed on both sides of the central frame. The left arm group and the right arm group each includes a front arm assembly assembled on a first end of the central frame, a rear arm assembly assembled on a second end of the central frame, and a middle arm assembly assembled on the central frame. The middle arm assembly is located between the front arm assembly and the rear arm assembly. The middle arm assembly includes a first rotor assembly, the front arm assembly includes a second rotor assembly, and the rear arm assembly includes a third rotor assembly. In an output direction of downwash flow fields of the left arm group and the right arm group, a height of a rotation plane on which the first rotor assembly is located is lower than heights of rotation planes on which the second rotor assembly and the third rotor assembly are respectively located. The agricultural unmanned aerial vehicle also includes a spraying system detachably installed on the central frame. The spraying system includes nozzle assemblies, and the nozzle assemblies are respectively assembled on the middle arm assembly of the left arm group and on the middle arm assembly of the right arm group. The control circuit is configured to control the left arm group and the right arm group to adjust flight attitude of the agricultural unmanned aerial vehicle. The left arm group and the right arm group output the downwash flow fields in a direction towards the nozzle assemblies, respectively.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic top-view of an exemplary agricultural unmanned aerial vehicle consistent with disclosed embodiments of the present disclosure;

FIG. 2 illustrates a three-dimensional schematic diagram of an exemplary agricultural unmanned aerial vehicle consistent with disclosed embodiments of the present disclosure;

FIG. 3 illustrates a schematic front-view of an exemplary agricultural unmanned aerial vehicle consistent with disclosed embodiments of the present disclosure;

FIG. 4 illustrates a schematic diagram of a left arm group and a right arm group located on a central frame in a folded state consistent with disclosed embodiments of the present disclosure;

FIG. 5 illustrates a schematic diagram of a right arm group in an unfolded state consistent with disclosed embodiments of the present disclosure;

FIG. 6 illustrates an exploded schematic diagram of a left arm group and a right arm group consistent with disclosed embodiments of the present disclosure;

FIG. 7 illustrates a schematic side-view of a right arm group consistent with disclosed embodiments of the present disclosure; and

FIG. 8 illustrates a schematic diagram of an exemplary agricultural unmanned aerial vehicle in a spraying operation state consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

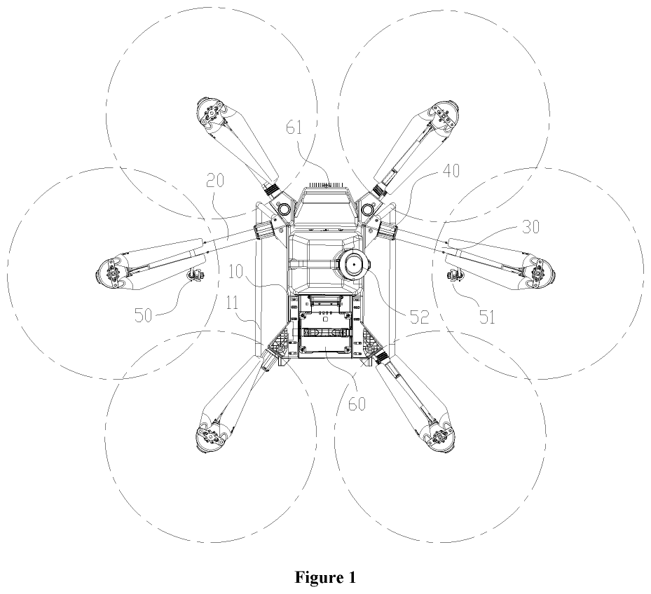

The present disclosure provides an agricultural unmanned aerial vehicle. Referring to FIG. 1, the agricultural unmanned aerial vehicle may include a central frame 10, a fuselage assembly 60 and a control circuit installed on the central frame 10, a left arm group 20 and a right arm group 30 symmetrically and fixedly disposed on both sides of the central frame 10, and a detachable spraying system 50 installed on the central frame 10. The control circuit may be installed inside the central frame 10, and may be electrically connected to the left arm group 20 and the right arm group 30. The control circuit may be configured to control the movement of the left arm group 20 and the right arm group 30, to adjust the flying attitude of the agricultural unmanned aerial vehicle. For example, the control circuit may control the left arm group 20 and the right arm group 30 to execute a corresponding control instruction, such that the unmanned aerial vehicle may perform straight flying, turning, ascent, or descent action, etc. The control circuit may also control the spraying system 50 to perform a spraying operation, e.g., controlling the spraying volume, spraying duration, and injection pressure, etc.

The left arm group 20 and the right arm group 30 may be symmetrically distributed with respect to each other to maintain balance of the unmanned aerial vehicle during the flight. The left arm group 20 and the right arm group 30 each may include a front arm assembly 21, a rear arm assembly 23, and a middle arm assembly 22 assembled on the central frame 10. The middle arm assembly 22 may be located between the front arm assembly 21 and the rear arm assembly 23. The front arm assembly 21, the rear arm assembly 23 and the middle arm assembly 22 may be radially extended outward from the central frame 10. The middle arm assembly 22 may include a first rotor assembly 221, the front arm assembly 21 may include a second rotor assembly 211, and the rear arm assembly 23 may include a third rotor assembly 231. Under the control of the control circuit, the first rotor assembly 221, the second rotor assembly 211, and the third rotor assembly 231 may perform corresponding rotation actions, e.g., all of them may rotate at a same rotation speed, or one or more of them may rotate at a rotation speed different from rotation speed of another rotor assembly.

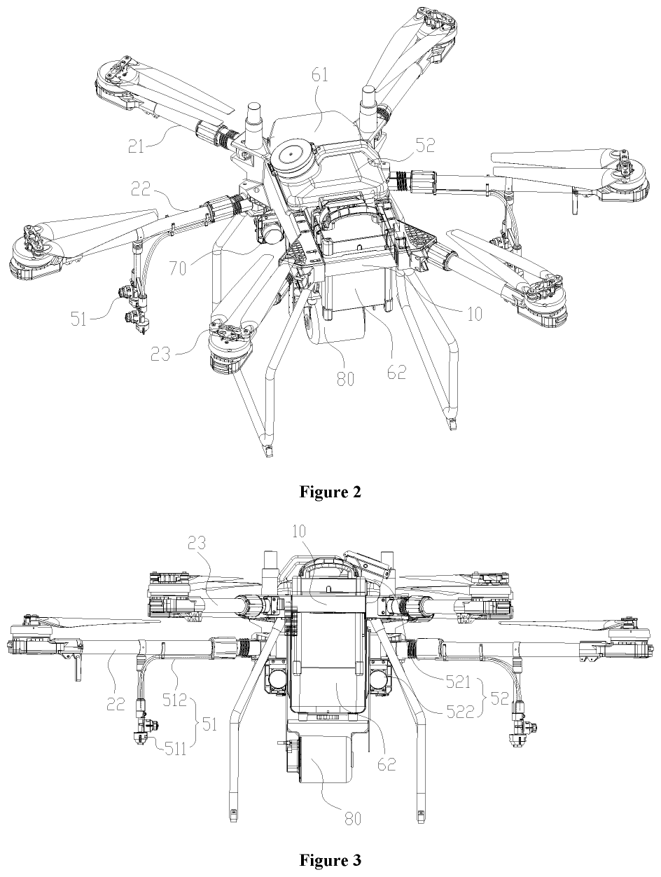

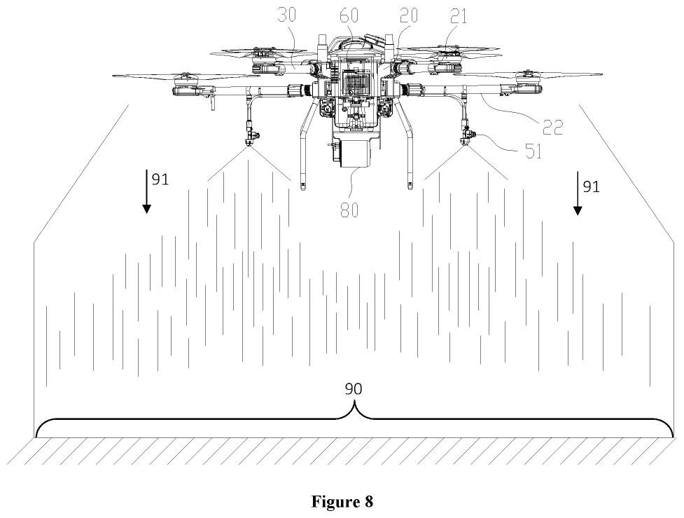

Referring to FIGS. 2, 3, and 8, in an output direction of the downwash flow fields of the left arm group 20 and the right arm group 30, at least one of the first rotor assembly 221, the second rotor assembly 211, or the third rotor assembly 231 may have a rotation plane at a different height. An output direction of a downwash flow field, as used herein, may refer to the direction of a downwash airflow formed by propeller(s) during operation, such as shown by arrows 91 in FIG. 8. For example, a height of the rotation plane where the first rotor assembly 221 is located may be smaller than heights of the rotation planes where the second rotor assembly 211 and the third rotor assembly 231 are located. Correspondingly, the second rotor assembly 211 and the third rotor assembly 231 may move towards the first rotor assembly 221, such that the downwash flow fields generated by the second rotor assembly 211 and the third rotor assembly 231 may at least partially superimpose on the downwash flow field generated by the first rotor assembly 221. Correspondingly, wind force of the downwash flow field at the first rotor assembly 221 may increase, and the downwash flow fields of the first rotor assembly 221, the second rotor assembly 211, and the third rotor assembly 231 may be connected to each other. Therefore, the downwash flow fields may form as a whole field, and the range of the downwash flow fields may be well controlled. FIG. 8 illustrates one example of a whole range 90 covered by the downwash flow fields on the ground.

The spraying system 50 may include nozzle assemblies 51, and the nozzle assemblies 51 may be respectively assembled on the middle arm assembly 22 of the left arm group 20 and the middle arm assembly 22 of the right arm group 30. The nozzle assemblies 51 may spray at the same time to enable the opposite reaction force to equally act on the two symmetrical middle arm assemblies 22, and the agricultural unmanned aerial vehicle may have desired flight stability. The control circuit may be configured to control the operations of the left arm group 20, the right arm group 30 and the spraying system 50, and the left arm group 20 and the right arm group 30 may respectively output the downwash flow fields in a direction towards the nozzle assembly 51.

The nozzle assembly 51 may be configured to spray liquid to the crops in the flight path of the agricultural unmanned aerial vehicle, and may be located on the middle arm assembly 22. The downwash flow field generated by the first rotor assembly 221 may act on the liquid sprayed from the nozzle assembly 51. The downwash flow fields of the second rotor assembly 211 and the third rotor assembly 231 may respectively intersect the downwash flow field generated by the first rotor assembly 221. Therefore, the liquid sprayed from the nozzle assembly 51 may be limited in the range of the downwash flow fields of the second rotor assembly 211 and the third rotor assembly 231. The spraying system 50 may have a highly controllable spraying liquid range, and the dripping direction of the liquid may be orderly and highly controllable. The liquid sprayed from the spraying system 50 may be mainly concentrated in the range of the downwash flow field generated by the first rotor assembly 221. Under the superimposed action of the downwash flow fields of the second rotor assembly 211 and the third rotor assembly 231, the wind force of the downwash flow field generated by the first rotor assembly 221 may increase, which may improve the penetration capacity of the liquid.

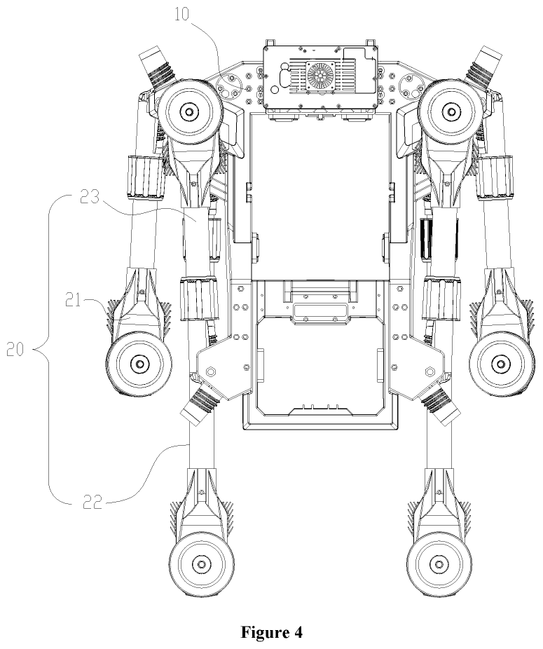

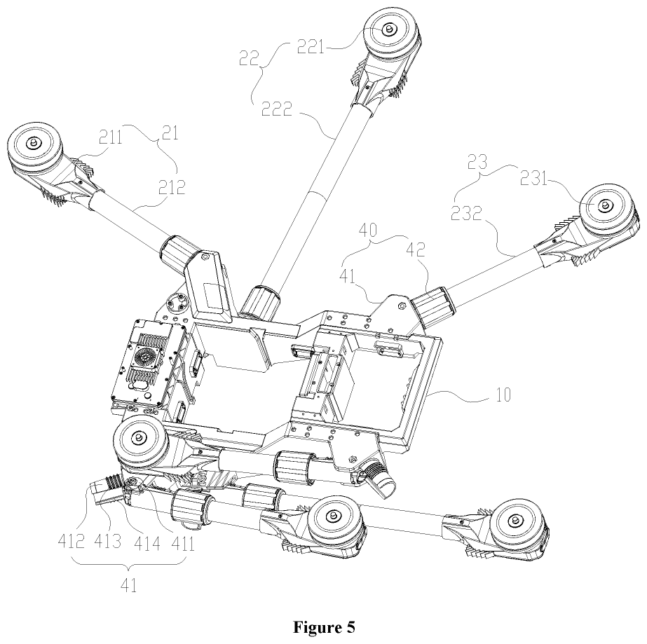

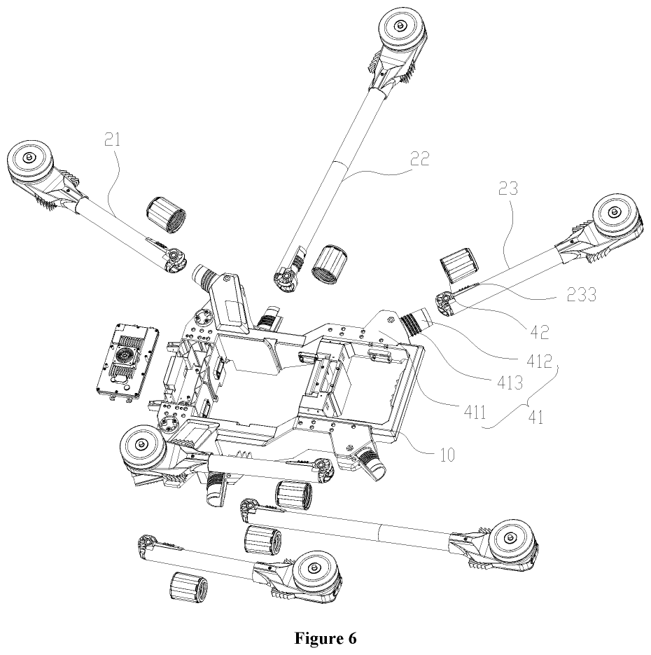

Referring to FIG. 4 and FIG. 5, in one embodiment, the first rotor assembly 221 may be located at an end of the middle arm assembly 22, the second rotor assembly 211 may be located at an end of the front arm assembly 21, and the third rotor assembly 231 may be located at an end of the rear arm assembly 23. The first rotor assembly 221, the second rotor assembly 211, and the third rotor assembly 231 may be respectively located in an outermost peripheral area of the unmanned aerial vehicle, and the unmanned aerial vehicle may have a substantially large area of the downwash flow field.

A height of the end of the middle arm assembly 22 may be smaller than a height of the end of the front arm assembly 21, and the height of the end of the middle arm assembly 22 may be smaller than a height of the end of the rear arm assembly 23. The end of the middle arm assembly 22 may be located below the front arm assembly 21 and the rear arm assembly 23. Correspondingly, the height of the rotation plane of the first rotor assembly 221 may be smaller than the height of the rotation plane of the second rotor assembly 211 and the height of the rotation plane of the third rotor assembly 231.

Optionally, in the direction of the downwash flow field, a propeller disc range of the first rotor assembly 221 may at least partially overlap a propeller disc range of the second rotor assembly 211. A propeller disc range, as used herein, may refer to a space range or a flat area where the air-in is influenced by the corresponding rotor assembly in operation (e.g., corresponding rotating propeller). Optionally, in the direction of the downwash flow field, a propeller disc range of the third rotor assembly 231 may at least partially overlap the propeller disc range of the first rotor assembly 221. Therefore, when the unmanned aerial vehicle is in flight, the downwash flow fields generated by the second rotor assembly 211 and the third rotor assembly 231 may act on the downwash flow field generated by the first rotor assembly 221. The downwash flow field generated by the first rotor assembly 221 may provide a large force, and may provide a large energy for the liquid, and, thus, the liquid may have strong penetration capacity.

The rotation plane of the first rotor assembly 221 may be at a plane different from the rotation planes of the second rotor assembly 211 and the third rotor assembly 231. Optionally, the rotation plane of the second rotor assembly 211 may be at a same plane as the rotation plane of the third rotor assembly 231. The first rotor assembly 221 may be located in the middle of the central frame 10, and the second rotor assembly 211 and the third rotor assembly 231 may be located on both sides of the first rotor assembly 221. The downwash flow fields generated by the second rotor assembly 211 and the third rotor assembly 231 may act on both sides of the downwash flow field generated by the first rotor assembly 221, and may at least partially overlap the downwash flow field generated by the first rotor assembly 221, such that the downwash flow field generated by the first rotor assembly 221 may be strengthened. When the nozzle assembly 51 is installed on the middle arm assembly 22, the liquid sprayed from the nozzle assembly 51 may be sprayed on the crops under the action of the strengthened downwash flow field, and may have strong penetration capacity.

The middle arm assembly 22 may include a first connecting rod group 222 for connecting the first rotor assembly 221 and the central frame 10. The first connecting rod group 222 may be configured to support the first rotor assembly 221, and may maintain a relative position between the first rotor assembly 221 and the central frame 10 to be substantially stable. The front arm assembly 21 may include a second connecting rod group 212 for connecting the second rotor assembly 211 and the central frame 10. The rear arm assembly 23 may include a third connecting rod group 232 for connecting the third rotor assembly 231 and the central frame 10. Correspondingly, the second connecting rod group 212 and the third connecting rod group 232 may have a same function as the first connecting rod group 222. A height of the first connecting rod group 222 may be smaller than a height of the second connecting rod group 212, and the height of the first connecting rod group 222 may be smaller than a height of the third connecting rod group 232.

The first connecting rod group 222, the second connecting rod group 212, and the third connecting rod group 232 may have a structure with linear shape or partially curved shape. A rotation plane position of the first rotor assembly 221 may be accordingly adjusted according to a connection position between the first connecting rod group 222 and the central frame 10 and the shape of the first connecting rod group 222. For example, the first connecting rod group 222, the second connecting rod group 212, and the third connecting rod group 232 each may have a structure with linear shape. The rotation plane of the first rotor assembly 221 with respect to the second rotor assembly 211 and the third rotor assembly 231 may be determined by an installation height of the first connecting rod group 222 on the central frame 10. In an optional embodiment, when being viewed from the side of the unmanned aerial vehicle, the connecting positions where the first connecting rod group 222, the second connecting rod group 212, and the third connecting rod group 232 are respectively connected to the central frame 10 may be distributed in a triangle shape, and the first connecting rod group 222 may be at a lowest position.

The connection positions where the first connecting rod group 222, the second connecting rod group 212, and the third connecting rod group 232 are connected to the central frame 10 may be adjusted, to adjust the relative positions of the first rotor assembly 221, the second rotor assembly 211, and the third rotor assembly 231. Therefore, the range of the downwash flow field of the unmanned aerial vehicle may be adjusted, and the distribution of the downwash flow field may be conveniently adjusted.

The nozzle assembly 51 may be installed on the middle arm assembly 22. The opposite reaction force generated during spraying may act on the first connecting rod group 222, and may be transmitted to the central frame 10 through the first connecting rod group 222. In one embodiment, a pipe diameter of the first connecting rod group 222 may be larger than a pipe diameter of the second connecting rod group 212, and/or the pipe diameter of the first connecting rod group 222 may be larger than a pipe diameter of the third connecting rod group 232.

The pipe diameter of the first connecting rod group 222 may be substantially large, and, thus, the rigidity of the first connecting rod group 222 may be higher than the rigidity of the second connecting rod group 212 and/or the third connecting rod group 232. The opposite reaction force of the nozzle assembly 51 may act on the first connecting rod group 222, which may have little effect on the flight stability of the agricultural unmanned aerial vehicle, and the control circuit may easily control the unmanned aerial vehicle to fly stably. The pipe diameters of the second connecting rod group 212 and/or the third connecting rod group 232 may be smaller than the pipe diameter of the first connecting rod group 222, which may reduce the overall weight of the unmanned aerial vehicle and improve the endurance under the premise of satisfying flying of the unmanned aerial vehicle.

Referring to FIG. 3 and FIG. 5, the nozzle assemblies 51 may be installed on the middle arm assembly 22 of the left arm group 20 and on the middle arm assembly 22 of the right arm group 30, and the spraying range may be related to lengths of the first connecting rod groups 222. In one embodiment, a length of the first connecting rod group 222 may be greater than a length of the second connecting rod group 212, and/or the length of the first connecting rod group 222 may be greater than a length of the third connecting rod group 232.

The length of the first connecting rod group 222 may be greater than the length of the second connecting rod group 212 and/or the third connecting rod group 232. Accordingly, the first rotor assembly 221, the second rotor assembly 211, and the third rotor assembly 231 may be distributed in a triangular shape. Because the rotation planes of the first rotor assembly 221, the second rotor assembly 211, and the third rotor assembly 231 are different, the propeller disc ranges of the first rotor assembly 221, the second rotor assembly 211, and the third rotor assembly 231 may partially overlap. For example, in an output direction of the downwash flow fields of the left arm group 20 and the right arm group 30, the propeller disc range of the first rotor assembly 221 may partially overlap the propeller disc range of the second rotor assembly 211, and/or the propeller disc range of the first rotor assembly 221 may partially overlap the propeller disc range of the third rotor assembly 231.

The nozzle assembly 51 may be installed on the first connecting rod group 222 and may be close to an end of the first rotor assembly 221. The first rotor assembly 221, the second rotor assembly 211 and the third rotor assembly 231 may be distributed in a triangular shape, such that the nozzle assembly 51 may be close to the downwash flow fields of the second rotor assembly 211 and the third rotor assembly 231. When the nozzle assembly 51 sprays liquid outward, the liquid may be in the range of the downwash flow fields generated by the first rotor assembly 221, the second rotor assembly 211 and the third rotor assembly 231, and may be highly concentrated.

In an optional embodiment, the middle arm assembly 22 may be fixedly connected to a first end of the central frame 10. Correspondingly, a distance between the first connecting rod group 222 and the third connecting rod group may be greater than a distance between the first connecting rod group 222 and the second connecting rod group. The first connecting rod group 222 may be close to the second connecting rod group 212. The first connecting rod group 222 may be connected to the central frame 10 and may be inclined towards the third connecting rod group 232. The first rotor assembly 221 may be located between the second rotor assembly 211 and the second rotor assembly 211, such that the propeller disc ranges of the second rotor assembly 211 and the third rotor assembly 231 may at least partially overlap the propeller disc range of the first rotor assembly 221 at their edges. When being viewed from the top view of the unmanned aerial vehicle, the circular range generated by the rotation of the first rotor assembly 221 may intersect the circular ranges generated by the rotations of the second rotor assembly 211 and the third rotor assembly 231.

Referring to FIG. 2 and FIG. 3, the connection portions between the first connecting rod group 222, the second connecting rod group 212, and the third connecting rod group 232 and the central frame 10 may be adjusted, such that the vibration force acting on the central frame 10 by the first rotor assembly 221, the second rotor assembly 211 and the third rotor assembly 231 may be balanced.

In one embodiment, the first rotor assembly 221 may include a first motor and a first propeller installed on an output shaft of the first motor. The first motor may drive the first propeller to rotate to generate the downwash flow field. The first propeller may contain two or more blades. During the rotation of the first propeller, the blades may form a circular propeller disc range, and the downwash flow field may be extended downward from the circular propeller disc range. The second rotor assembly 211 and the third rotor assembly 231 may have a same structure as the first rotor assembly 221. The second rotor assembly 211 may include a second motor and a second propeller installed on an output shaft of the second motor, and the third rotor assembly 231 may include a third motor and a third propeller installed on an output shaft of the third motor.

The first rotor assembly 221, the second rotor assembly 211 and the third rotor assembly 231 may be in different rotation planes. The installation position of the first rotor assembly 221 with respect to the second rotor assembly 211 and the third rotor assembly 231 may be adjusted, to change the range of the downwash flow field of the unmanned aerial vehicle. In the output direction of the downwash flow fields of the left arm group 20 and the right arm group 30, the propeller disc range of the first propeller may partially overlap the propeller disc range of the second propeller, and/or the propeller disc range of the first propeller may partially overlap the propeller disc range of the third propeller.

A first downwash flow field may be generated in the propeller disc range of the first propeller, a second downwash flow field may be generated by the second propeller, and a third downwash flow field may be generated by the third propeller. Because the first propeller is located below the second propeller and the third propeller, correspondingly, the downwash flow fields generated by the second propeller and the third propeller may be partially superimposed on the first downwash flow field, and, thus, the downward force of the first downwash flow field may become substantially great. The liquid in the first downwash flow field may have increased penetration capacity, and may have desired spraying effect.

The front arm assembly 21, the rear arm assembly 23, and the middle arm assembly 22 may be radially and fixedly connected to the central frame 10. The unmanned aerial vehicle may have a large unfolded size, and it is difficult to transport the unmanned aerial vehicle. In one embodiment, the front arm assembly 21, the rear arm assembly 23 and the middle arm assembly 22 each may be rotatably connected to the central frame 10. Further, the front arm assembly 21, the rear arm assembly 23, and the middle arm assembly 22 each may rotate and approach to the central frame 10 to be in a folded position, or may be extended radially outward from the central frame 10 to be in a flying position.

Referring to FIG. 4 and FIG. 5, when the unmanned aerial vehicle is in an application scenario such as transportation or storage, the spraying system 50 and any other accessory may be removed from the central frame 10, such that the unmanned aerial vehicle may be folded and unfolded. For example, the left arm group 20 and the right arm group 30 may rotate towards the central frame 10 to make the unmanned aerial vehicle in a folded state. When the unmanned aerial vehicle is in a flying or standby state, the left arm group 20 and the right arm group 30 may be in an unfolded state. Correspondingly, the front arm assembly 21, the rear arm assembly 23, and the middle arm assembly 22 may be rotatably connected to the central frame 10. For example, the left arm group 20 may rotate counterclockwise around the central frame 10, and the right arm group 30 may rotate clockwise around the center frame 10. Therefore, the left arm group 20 and the right arm group 30 may be folded to the central frame 10, or may be reversely rotated to be in an unfolded state.

The middle arm assembly 22 may be located on a plane different from a plane where the front arm assembly 21 is located and a plane where the rear arm assembly 23 is located. The middle arm assembly 22 may have a same rotation direction as the front arm assembly 21 and the rear arm assembly 23. Alternatively, the middle arm assembly 22 may have a rotation direction opposite to at least one of the front arm assembly 21 or the rear arm assembly 23. In one embodiment, the front arm assembly 21, the rear arm assembly 23, and the middle arm assembly 22 may have the same rotation direction. In another embodiment, the front arm assembly 21 and the middle arm assembly 22 may rotate towards the rear arm assembly 23, and the rear arm assembly 23 may rotate towards the middle arm assembly 22.

The middle arm assembly 22 may be close to the front arm assembly 21, and the middle arm assembly 22 may have an overall length greater than the front arm assembly 21. The middle arm assembly 22 may rotate towards the rear arm assembly 23 to be folded at the central frame 10. Accordingly, the length of the middle arm assembly 22 protruding from the central frame 10 may be reduced, which may reduce the overall volume of the unmanned aerial vehicle.

When the front arm assembly 21 and the rear arm assembly 23 are in a same plane, the front arm assembly 21 may rotate towards the rear arm assembly 23. Therefore, the front arm assembly 21 may be attached to the central frame 10 close to the rear arm assembly 23, or may be attached to the rear arm assembly 23. Alternatively, the front arm assembly 21 may rotate towards the rear arm assembly 23, and the rear arm assembly 23 may rotate towards the front arm assembly 21, such that the front arm assembly 21 and the rear arm assembly 23 may be attached to the central frame 10.

When the front arm assembly 21 and the rear arm assembly 23 are in different planes, the front arm assembly 21 may rotate towards the rear arm assembly 23, such that the front arm assembly 21 may be attached to the central frame 10 close to the rear arm assembly 23, or may be attached to the rear arm assembly 23. Alternatively, the front arm assembly 21 may rotate towards the rear arm assembly 23, and the rear arm assembly 23 may rotate towards the front arm assembly 21, such that the front arm assembly 21 and the rear arm assembly 23 may be attached to the central frame 10.

The front arm assembly 21, the rear arm assembly 23, and the middle arm assembly 22 may be configured to be rotatably installed on the central frame 10, which may facilitate to be conveniently folded and unfolded. The middle arm assembly 22 may have a rotation plane different from the front arm assembly 21 and the rear arm assembly 23, which may improve the form of the folded state of the unmanned aerial vehicle, may enrich the storage state of the unmanned aerial vehicle, and may facilitate the transportation of the unmanned aerial vehicle.

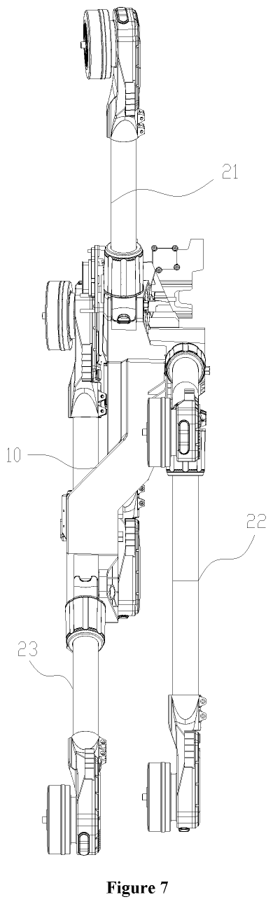

Referring to FIG. 6 and FIG. 7, the unmanned aerial vehicle may include locking devices 40 fixed to the central frame 10. The front arm assembly 21, the rear arm assembly 23, and the middle arm assembly 22 may be fixed on or may be rotatably connected to the central frame 10 through a corresponding locking device 40. The left arm group 20 and the right arm group 30 may be rotatably connected to the central frame 10. When the unmanned aerial vehicle is in flight, the left arm group 20 and the right arm group 30 may be in the unfolded position. The locking devices 40 may be fixedly connected to the central frame 10, and may be configured to lock the front arm assembly 21, the rear arm assembly 23 and the middle arm assembly 22 in the unfolded position of the central frame 10.

In one embodiment, the agricultural unmanned aerial vehicle may be a six-rotor agricultural unmanned aerial vehicle, and three spaced locking devices 40 may be fixedly connected to a side of the central frame 10. The front arm assembly 21, the rear arm assembly 23 and the middle arm assembly 22 may be respectively assembled on the central frame 10 by a corresponding locking device 40, and the front arm assembly 21, the rear arm assembly 23 and the middle arm assembly 22 may respectively rotate with respect to the central frame 10 through the corresponding locking device 40.

Accordingly, the locking device 40 may have a locked state and an unlocked state. When the locking devices 40 lock the front arm assembly 21, the rear arm assembly 23, and the middle arm assembly 22, the front arm assembly 21, the rear arm assembly 23, and the middle arm assembly 22 may be fixed with respect to the central frame 10, such that the front arm assembly 21, the rear arm assembly 23, and the middle arm assembly 22 may be in the unfolded position. The locking devices 40 may unlock the front arm assembly 21, the rear arm assembly 23 and the middle arm assembly 22, and the front arm assembly 21, the rear arm assembly 23 and the middle arm assembly 22 may rotate with respect to the central frame 10, such that the front arm assembly 21, the rear arm assembly 23, and the middle arm assembly 22 may be folded towards the central frame 10 and may be in a folded position. Therefore, states of the left arm group 20 and the right arm group 30 may be conveniently adjusted through the locking devices 40.

Referring to FIG. 5 and FIG. 6, in one embodiment, the locking device 40 may include a fixing base 41 fixedly connected to the central frame 10 and a locking element 42. The front arm assembly 21, the rear arm assembly 23, and the middle arm assembly 22 may be respectively pivotally connected to a corresponding fixing base 41. The front arm assembly 21, the rear arm assembly 23 or the middle arm assembly 22 each may be sleeved in a locking element 42. The locking element 42 may be locked to the fixing base 41, and may limit the rotation of the front arm assembly 21, the rear arm assembly 23 or the middle arm assembly 22 with respect to the corresponding fixing base 41.

The middle arm assembly 22 may be used as an example for description. One end of the first connecting rod group 222 may be pivotally connected to the fixing base 41, such that the middle arm assembly 22 may be rotatably connected to the fixing base 41. The locking element 42 may be sleeved outside the first connecting rod group 222, and may rotate along with the first connecting rod group 222. Optionally, when the first connecting rod group 222 rotates to the unfolded position, the first connecting rod group 222 may lean against the fixing base 41 to be in a preset unfolded position. The locking element 42 may move along an axial direction of the first connecting rod group 222, and may be connected to the fixed base 41 through a screw connection or any other suitable connection method. The locking element 42 may be connected to the fixing base 41, and the first connecting rod group 222 may be limited on the fixing base 41 by the locking element 42, such that the middle arm assembly 22 may be in the unfolded position. The reverse operation may enable the middle arm assembly 22 to be in a rotatable state, and the middle arm assembly 22 may be conveniently folded or unfolded. The connection modes of the front arm assembly 21 and the rear arm assembly 23 to the central frame 10 may be the same as or similar to the connection mode of the middle arm assembly 22 to the central frame 10.

In an optional embodiment, the fixing base 41 may include a fixing portion 411 fixedly connected to the central frame 10 and a connecting portion 412 protruding from the fixing portion 411. The fixing portion 411 and the connecting portion 412 may be arranged in a T-structure. Optionally, the connecting portion 412 may be arranged obliquely with respect to the fixing portion 411. The locking element 42 may be threadedly connected with the connecting portion 412. The front arm assembly 21, the rear arm assembly 23 or the middle arm assembly 22 may be pivotally connected to the connecting portion 412. The locking element 42 may be fixed to the connecting portion 412 and may be sleeved outside the front arm assembly 21, the rear arm assembly 23 or the middle arm assembly 22.

The fixing base 41 may include an insertion slot 414 configured in the connecting portion 412. The front arm assembly 21, the rear arm assembly 23 or the middle arm assembly 22 may be inserted into the insertion slot 414 and may be pivotally connected to the connecting portion 412. The fixing base 41 may further include a threaded portion 223 configured on the outer wall surface of the connecting portion 412, and the locking element 42 may be threadedly connected with the threaded portion 223.

Referring to FIG. 5 and FIG. 6, the middle arm assembly 22 may be used as an example for description. The first connecting rod group 222 may be provided with a through-hole, and a connecting shaft may pass through the through-hole and may be pivotally connected to the connecting portion 412. The insertion slot 414 may be configured on the connecting portion 412, and the first connecting rod group 222 may be inserted into the insertion slot 414 and may be rotatably connected with the connecting shaft. An external thread 413 may be provided on the outer peripheral surface of the connecting portion 412. The locking element 42 may have a tubular structure, and the inner side surface of the locking element 42 may be provided with an internal thread. The fixing base 41 may further include the threaded portion 223 provided on the outer wall surface of the connecting portion 412, and the locking element 42 may be threadedly connected with the threaded portion 223. The locking element 42 may be sleeved on the first connecting rod group 222 and may be threadedly connected with the threaded portion 223. The wall surface of the locking element 42 may be used to limit the rotation and movement of the first connecting rod group 222.

In an optional embodiment, the front arm assembly 21, the rear arm assembly 23, and the middle arm assembly 22 may be partially protruded to form a boss portion 233. The boss portion 233 may be located in the insertion slot 414, and the boss portion 233 may be provided with the external thread 413 matched the threaded portion 223.

For example, the boss portion 233 may be configured on the outer surface of the first connecting rod group 222, and the shape and width of the boss portion 233 may match the slot of the insertion slot 414. When the first connecting rod group 222 is assembled to the fixing base 41, the boss portion 233 and the insertion slot 414 may complement each other to form a circumferential surface. The boss portion 233 may be provided with the external thread 413 matched the threaded portion 223. When the locking element 42 is threadedly connected to the first connecting rod group 222, the internal thread may be threadedly connected to the boss portion 233, such that the first connecting rod group 222 may be threadedly connected to the locking element 42, which may further limit the rotation position of the first connecting rod group 222 to make a firm connection.

The front arm assembly 21, the rear arm assembly 23 and the middle arm assembly 22 may be rotatably connected to the central frame 10. The rotation plane of the middle arm assembly 22 may be parallel to the rotation planes of the front arm assembly 21 and the rear arm assembly 23. Further, the folding angles of the front arm assembly 21, the rear arm assembly 23, and the middle arm assembly 22 may also be adjusted according to the folded space of the unmanned aerial vehicle. For example, the middle arm assembly 22 and the rear arm assembly 23 may rotate in a plane, and the front arm assembly 21 may be inclined with respect to the rotation direction of the middle arm assembly 22.

In one embodiment, the central frame 10 may further include a linkage assembly 11 assembled on the central frame 10. The linkage assembly 11 may be configured to drive the front arm assembly 21, the rear arm assembly 23, and the middle arm assembly 22 to synchronously or sequentially rotate. The linkage assembly 11 may be installed on the central frame 10, and may be manually started. For example, by pulling a wrench, the linkage mechanism may drive the front arm assembly 21, the rear arm assembly 23, and the middle arm assembly 22 to synchronously or sequentially rotate. Alternatively, the linkage assembly 11 may be automatically started. For example, a motor-driven linkage mechanism may drive the front arm assembly 21, the rear arm assembly 23, and the middle arm assembly 22 to synchronously or sequentially rotate. The linkage assembly 11 may fold or unfold the left arm group 20 and the right arm group 30 to improve the efficiency for unfolding and folding the unmanned aerial vehicle.

Referring to FIG. 3 and FIG. 8, the spraying system 50 may include a water tank assembly 52 detachably installed on the central frame 10. The water tank assembly 52 may be a container for containing liquid. The liquid outputted from the water tank assembly 52 may be an aqueous solution with a preset pressure. The water tank assembly 52 may be connected to the nozzle assembly 51 through a pipe, and may be configured to deliver liquid to the nozzle assembly 51. The nozzle assembly 51 may be installed on the first connecting rod assembly 222, and may be located in the range of the downwash flow field of the first rotor assembly 221. The nozzle assembly 51 may spray misty or droplet-like liquid, and such type of liquid may be accelerated and sprayed towards the crops under the action of the downward pressure. Correspondingly, when the downward pressure is large, the impact force of the liquid may be large, and the penetration effect may be desired. The middle arm assembly 22 may be partially overlapped with the front arm assembly 21 and the rear arm assembly 23, which may enhance the downward pressure at the middle arm assembly 22, and may improve the penetration capability of the liquid.

In an optional embodiment, the water tank assembly 52 may include a tank body 521 and a pump device 522 detachably mounted on the tank body 521. The pump device 522 may be connected to the nozzle assembly 51 through a pipe 512. The tank body 521 may be used for containing liquid, and the pump device 522 may be electrically connected to the control circuit. The pump device 522 may adjust the pressure of the liquid in the tank body 521 and may deliver the liquid to the nozzle assembly 51 through the pipe. The nozzle assembly 51 may spray the liquid with a preset pressure.

The control circuit may control the operations of the pump device 522, some examples of the controllable operations are start, stop, boost or depressurization, etc., may adjust the pressure of liquid delivered by the pump device 522 to the nozzle assembly 51, or may adjust a flow diameter of the nozzle assembly 51, such that the pressure and initial velocity of the liquid sprayed by the nozzle assembly 51 may be adjustable. The pump device 522 may be detachably installed on the tank body 521. When the liquid in the tank body 521 is used up or a different solution needs to be replaced, the pump device 522 may be removed from the tank body 521, and a new tank body 521 may be replaced, which may improve the continuous operation efficiency of the agricultural unmanned aerial vehicle.

Referring to FIG. 2 and FIG. 3, in one embodiment, the nozzle assembly 51 may include the pipe 512 connected to the water tank assembly 52 and a nozzle element 511 fixed on the middle arm assembly 22 and connected to the pipe 512. The nozzle element 511 may be located in the range of the downwash flow field outputted by the middle arm assembly 22. The middle arm assembly 22 may have a long length, and the first rotor assembly 221 may be far away from the central frame 10. The pipe 512 may be extended from the tank body 521 to the nozzle element 511, and the pipe 512 may be fixed to the first connecting rod group 222. The nozzle element 511 and the first propeller may be respectively located on both sides of the first connecting rod group 222. When the nozzle element 511 sprays liquid, an opposite reaction force may act on the first connecting rod group 222. The middle arm assembly 22 may improve the strength of the first connecting rod group 222 to balance the opposite reaction force generated when the nozzle element 511 sprays the liquid. Therefore, the agricultural unmanned aerial vehicle may have desired flight stability when performing the spraying operation.

The overall weight of agricultural unmanned aerial vehicle may be a variable, and may gradually become smaller as the spraying operation progresses. Accordingly, the center of gravity of the unmanned aerial vehicle may change accordingly. In one embodiment, the water tank assembly 52 may be located between the first end and the second end of the central frame 10, and the center of gravity of the water tank assembly 52 may be located on a symmetry plane of the central frame 10.

The central frame 10 may have a ring structure, and the first end and the second end thereof may be connected by a side wall. The left arm group 20 and the right arm group 30 may be assembled outside the side wall. A symmetric storage space may be formed in a closed region of the central frame 10, and the tank body 521 may be installed in the storage space of the central frame 10 and may be symmetrically disposed. As the liquid volume in the tank body 521 changes, the center of gravity thereof may be always on the symmetry plane of the unmanned aerial vehicle, and the change of the position of the center of gravity of the unmanned aerial vehicle may have little effect on flight stability.

The fuselage assembly 60 may include a battery device 62 detachably installed on the central frame 10. The battery device 62 may be located at the second end of the central frame 10, and may be symmetrically distributed with respect to the symmetry plane of the central frame 10, which may have little effect on the shift of center of gravity of the unmanned aerial vehicle. The battery device 62 may be plug-connected to the central frame 10 from the second end to the first end of the central frame 10, and may be electrically connected to the control circuit. The battery device 62 may be plug-connected to the central frame 10 to be fixed on the central frame 10. In another embodiment, the battery device 62 may be snap-connected to the central frame 10. Alternatively, the battery device 62 may be inserted into a preset position of the central frame 10, and may be locked on the central frame 10 through the locking element 42. In certain embodiments, the central frame 10 may be provided with a mounting slot, and the battery device 62 may be plug-connected to the mounting slot.

The mounting slot may be configured to accommodate the battery device 62, which may have a guiding effect and may protect the connection portion between the battery device 62 and the control circuit. For example, an electrode terminal of the battery device 62 and an electrical terminal of the control circuit both may be located in the mounting slot. When the battery device 62 slides along the mounting slot to a preset position, the electrode terminal of the battery device may be electrically connected to the electrical terminal of the control circuit, and the battery device 62 may supply power for the control circuit. The installation position of the battery device may be accurate, and the electrical connection may be reliable.

The fuselage assembly 60 may include a head unit 61 fixedly connected to the central frame 10. The head unit 61 may be located at the first end of the central frame 10 and may be communicatively connected with the control circuit. The head unit 61 and the battery device 62 may be respectively located on both ends of the central frame 10 to balance the weight on the first end and the second end of the unmanned aerial vehicle to avoid weight concentration at one end, such that the flight stability of the unmanned aerial vehicle may be desired. The head unit 61 may be communicatively connected with the control circuit to control the control circuit to output a corresponding control instruction, and then control the unmanned aerial vehicle to perform a corresponding operation.

In one embodiment, the agricultural unmanned aerial vehicle may further include an obstacle avoidance unit 80 communicatively connected with the control circuit. The obstacle avoidance unit 80 may be fixed to the second end or the first end of the central frame 10. The obstacle avoidance unit 80 may be configured to detect obstacles on the flight path of the agricultural unmanned aerial vehicle, such that the unmanned aerial vehicle may perform avoidance actions in advance.

In one embodiment, the agricultural unmanned aerial vehicle may further include a photographing unit 70 communicatively connected with the control circuit. The photographing unit 70 may be located at the first end or the second end of the central frame 10. The photographing unit 70 may be configured to photograph and observe the crops on the flight path of the agricultural unmanned aerial vehicle and the spraying operation, such that the growth status of crops and the spraying operation of the agricultural unmanned aerial vehicle may be timely observed.

The above disclosed embodiments of the present disclosure may have following beneficial effects. The agricultural unmanned aerial vehicle may have a six-rotor structure. The downwash flow fields generated by the second rotor assembly and the third rotor assembly may at least partially superimpose on the downwash flow field generated by the first rotor assembly. The nozzle assembly may be configured in the range of the downwash flow field of the middle arm assembly of each of the left arm assembly and the right arm assembly. The liquid sprayed by the spraying system may be subjected to the action of the downwash flow field, and, thus, the penetration capacity of the liquid may be improved. The downwash flow fields outputted by the left arm group and the right arm group may have desired continuity. The spraying system may have a highly controllable spraying liquid range, and the dripping direction of the liquid may be orderly and highly controllable. The opposite reaction force generated when the spraying system sprays liquid may act on the middle arm assembly, and both sides of the agricultural unmanned aerial vehicle may be subjected to equal force. Therefore, the agricultural unmanned aerial vehicle may have desired flight stability and operational controllability.

The above detailed descriptions only illustrate certain exemplary embodiments of the present disclosure, and are not intended to limit the scope of the present disclosure. Those skilled in the art can understand the specification as whole and technical characteristics in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. An agricultural unmanned aerial vehicle, comprising:
a central frame;
a control circuit installed on the central frame;
a left arm group and a right arm group symmetrically and fixedly disposed on both sides of the central frame, wherein:
the left arm group and the right arm group each includes a front arm assembly assembled on a first end of the central frame, a rear arm assembly assembled on a second end of the central frame, and a middle arm assembly assembled on the central frame,
the middle arm assembly is located between the front arm assembly and the rear arm assembly,
the middle arm assembly includes a first rotor assembly, the front arm assembly includes a second rotor assembly, and the rear arm assembly includes a third rotor assembly, and
in an output direction of downwash flow fields of the left arm group and the right arm group, a height of a rotation plane on which the first rotor assembly is located is lower than heights of rotation planes on which the second rotor assembly and the third rotor assembly are respectively located; and
a spraying system detachably installed on the central frame, wherein:
the spraying system includes nozzle assemblies, and the nozzle assemblies are respectively assembled on the middle arm assembly of the left arm group and on the middle arm assembly of the right arm group,
the control circuit is configured to control the left arm group and the right arm group to adjust flight attitude of the agricultural unmanned aerial vehicle, and
the left arm group and the right arm group output the downwash flow fields in a direction towards the nozzle assemblies, respectively.

2. The agricultural unmanned aerial vehicle according to claim 1, wherein:
the first rotor assembly is located at an end of the middle arm assembly,
the second rotor assembly is located at an end of the front arm assembly,
the third rotor assembly is located at an end of the rear arm assembly,
a height of the end of the middle arm assembly is lower than a height of the end of the front arm assembly, and
the height of the end of the middle arm assembly is lower than a height of the end of the rear arm assembly.

3. The agricultural unmanned aerial vehicle according to claim 1, wherein:
the middle arm assembly includes a first connecting rod group for connecting the first rotor assembly and the central frame;
the front arm assembly includes a second connecting rod group for connecting the second rotor assembly and the central frame;
the rear arm assembly includes a third connecting rod group for connecting the third rotor assembly and the central frame;
a height of the first connecting rod group is lower than a height of the second connecting rod group; and
the height of the first connecting rod group is lower than a height of the third connecting rod group.

4. The agricultural unmanned aerial vehicle according to claim 3, wherein:
a pipe diameter of the first connecting rod group is larger than a pipe diameter of the second connecting rod group, and/or
the pipe diameter of the first connecting rod group is larger than a pipe diameter of the third connecting rod group.

5. The agricultural unmanned aerial vehicle according to claim 3, wherein:
a length of the first connecting rod group is larger than a length of the second connecting rod group, and/or
the length of the first connecting rod group is larger than a length of the third connecting rod group.

6. The agricultural unmanned aerial vehicle according to claim 1, wherein:
in the output direction of the downwash flow fields of the left arm group and the right arm group, a propeller disc range of the first rotor assembly partially overlaps a propeller disc range of the second rotor assembly.

7. The agricultural unmanned aerial vehicle according to claim 1, wherein:
in the output direction of the downwash flow fields of the left arm group and the right arm group, a propeller disc range of the first rotor assembly partially overlaps a propeller disc range of the third rotor assembly.

8. The agricultural unmanned aerial vehicle according to claim 1, wherein:
the middle arm assembly is fixedly connected to the first end of the central frame.

9. The agricultural unmanned aerial vehicle according to claim 1, wherein:
the front arm assembly, the rear arm assembly and the middle arm assembly are rotatably connected to the central frame, and
the front arm assembly, the rear arm assembly and the middle arm assembly are configured to rotate and approach to the central frame to be in a folded position, or extend radially outward from the central frame to be in a flying position.

10. The agricultural unmanned aerial vehicle according to claim 9, wherein:
the front arm assembly, the rear arm assembly and the middle arm assembly have a same rotation direction, or
the front arm assembly and the middle arm assembly are configured to rotate towards the rear arm assembly, and the rear arm assembly is configured to rotate towards the middle arm assembly.

11. The agricultural unmanned aerial vehicle according to claim 9, further including:
locking devices fixed on the central frame, wherein the front arm assembly, the rear arm assembly and the middle arm assembly are fixed on or are rotatably connected to the central frame through a corresponding locking device, respectively.

12. The agricultural unmanned aerial vehicle according to claim 11, wherein:
each locking device includes a fixing base fixedly connected to the central frame and a locking element, wherein:
the front arm assembly, the rear arm assembly and the middle arm assembly are pivotally connected to a corresponding fixing base, respectively,
the front arm assembly, the rear arm assembly or the middle arm assembly is sleeved in a corresponding locking element, and
the locking element is locked to the fixing base, and limits the rotation of the front arm assembly, the rear arm assembly or the middle arm assembly with respect to the corresponding fixing base.

13. The agricultural unmanned aerial vehicle according to claim 11, wherein:
the fixing base includes a fixing portion fixedly connected to the central frame and a connecting portion protruding from the fixing portion, wherein:
the front arm assembly, the rear arm assembly or the middle arm assembly is pivotally connected to a corresponding connecting portion, and
the locking element is fixed to the connecting portion and is sleeved outside the front arm assembly, the rear arm assembly or the middle arm assembly.

14. The agricultural unmanned aerial vehicle according to claim 13, wherein:
the locking element is threadedly connected with the connecting portion.

15. The agricultural unmanned aerial vehicle according to claim 13, wherein:
the fixing base includes an insertion slot configured in the connecting portion, and the front arm assembly, the rear arm assembly or the middle arm assembly is plug-installed on the insertion slot and is pivotally connected to the connecting portion, and
the fixing base further includes a threaded portion configured on an outer wall surface of the connecting portion, and the locking element is threadedly connected with the threaded portion.

16. The agricultural unmanned aerial vehicle according to claim 15, wherein:
the front arm assembly, the rear arm assembly, and the middle arm assembly are partially protruded to form a boss portion, wherein the boss portion is located inside the insertion slot, and the boss portion is provided with an external thread matched the threaded portion.

17. The agricultural unmanned aerial vehicle according to claim 11, wherein:
the rotation plane of the middle arm assembly is parallel to the rotation planes of the front arm assembly and the rear arm assembly.

18. The agricultural unmanned aerial vehicle according to claim 1, wherein:
the spraying system includes a water tank assembly detachably installed on the central frame, wherein the water tank assembly is connected to the nozzle assembly and configured to deliver liquid to the nozzle assembly.

19. The agricultural unmanned aerial vehicle according to claim 18, wherein:
the water tank assembly includes a tank body and a pump device detachably installed on the tank body, wherein the pump device is connected to the nozzle assembly, and is configured to adjust a pressure of the liquid in the tank body, and deliver the liquid to the nozzle assembly to enable the nozzle assembly to spray the liquid with a preset pressure.

20. The agricultural unmanned aerial vehicle according to claim 19, wherein:
the nozzle assembly includes a pipe connected to the water tank assembly and a nozzle element fixed on the middle arm assembly and connected to the pipe, wherein the nozzle element is located in the range of the downwash flow field outputted by the middle arm assembly.
